(19) United States
(12) Patent Application Publication
(10) Pub. No.: US 2016/0246957 A1
(43) Pub. Date: Aug. 25, 2016

(54) Method and Apparatus for Controlling Debug Port of Terminal Device

(71) Applicant: HUAWEI TECHNOLOGIES CO., LTD., Shenzhen (CN)

(72) Inventor: Jinhua Shen, Beijing (CN)

(21) Appl. No.: 15/029,695

(22) PCT Filed: Oct. 17, 2014
(86) PCT No.: PCT/CN2014/088833

§ 371 Date: Apr. 15, 2016

(30) Foreign Application Priority Data
Oct. 17, 2013 (CN) 201310489021.X

(51) Int. Cl. G06F 21/44; G06F 21/85

(52) U.S. Cl. CPC G06F 21/44; G06F 21/85

(57) ABSTRACT

A method and an apparatus for controlling a debug port of a terminal device where the method for controlling the debug port includes detecting a status of a universal serial bus (USB) port of a terminal device, detecting whether a screen of the terminal device is in a secure screen-locked state when the USB port is connected to a computer, and controlling a debug port of the terminal device when the screen is in the secure screen-locked state. According to the method and apparatus for controlling the debug port the security policy completeness of a terminal device can be improved, and security of user information on the terminal device is effectively ensured.

### CROSS-REFERENCE TO RELATED APPLICATIONS

This application is a U.S. National Stage of International Application No. PCT/CN2014/088833, filed on Oct. 17, 2014, which claims priority to Chinese Patent Application No. 201310489021.X, filed on Oct. 17, 2013, both of which are hereby incorporated by reference in their entireties.

### TECHNICAL FIELD

The present disclosure relates to the field of communications technologies, and in particular, to a method and an apparatus for controlling a debug port of a terminal device.

### BACKGROUND

In a terminal device such as a smartphone or a tablet computer in which an operating system such as an ANDROID system is installed, when a screen of the terminal device is in a locked state, a user cannot access, by means of a direct operation on the terminal device or a connection between a universal serial bus (USB) port and a computer, user data stored on the terminal device, such as contacts or confidential files. If the user needs to access the user data, the user needs to unlock the screen first. After the unlocking succeeds, the user can access the user data by means of a direct operation on the terminal device. After the unlocking succeeds, if the terminal device is connected to a computer using a USB port, the user may enable unified message service (UMS), media transfer protocol (MTP), and picture transfer protocol (PTP) modes in order to access the user data, or may enable a debug port such as an ANDROID debug bridge (ADB) port of the terminal device after the user confirms that debugging is authorized and debugging is allowed in order to access the user data.

If the terminal device is lost, and a third party cracks (root) the terminal device, the third party can access the user data by means of a connection between the terminal device and a computer implemented using third-party tool software (such as DALVIK debug monitor server (DDMS) or 360 mobile assistant). In this case, information security of the user cannot be ensured.

### SUMMARY

In view of this, a technical problem to be resolved in the present disclosure is how to ensure information security of a user.

To resolve the foregoing problem, according to a first aspect, the present disclosure provides a method for controlling a debug port of a terminal device, including detecting a status of a USB port of a terminal device, and when the USB port is connected to a computer, detecting whether a screen of the terminal device is in a secure screen-locked state, where the secure screen-locked state is preset in an operating system of the terminal device, and the screen that is locked can be successfully unlocked only after a user inputs correct unlocking information on the screen, and controlling a debug port of the terminal device when the screen is in the secure screen-locked state.

With reference to the first aspect, in a first possible implementation manner, controlling a debug port of the terminal device when the screen is in the secure screen-locked state includes disabling the debug port when the screen is in the secure screen-locked state.

With reference to the first possible implementation manner of the first aspect, in a second possible implementation manner, after disabling the debug port when the screen is in the secure screen-locked state, the method includes detecting whether the screen is successfully unlocked, and enabling the modulation port when the screen is successfully unlocked, or disabling the debug port when the screen is unsuccessfully unlocked.

With reference to the second possible implementation manner of the first aspect, in a third possible implementation manner, after enabling the debug port when the screen is successfully unlocked, or disabling the debug port when the screen is unsuccessfully unlocked, the method includes generating a historical record of the debug port according to an enabled state or a disabled state of the debug port.

With reference to the third possible implementation manner of the first aspect, in a fourth possible implementation manner, after generating a historical record of the debug port, the method includes detecting whether the USB port is disconnected from the computer, and clearing the historical record of the debug port when the USB port is disconnected from the computer, or when the USB port remains connected to the computer, detecting whether the screen is in a screen-locked state, and controlling the debug port according to the historical record of the debug port when the screen is in the screen-locked state.

To resolve the foregoing problem, according to a second aspect, the present disclosure provides an apparatus for controlling a debug port of a terminal device, including a detection unit configured to detect a status of a USB port of a terminal device, where the detection unit is further configured to detect whether a screen of the terminal device is in a secure screen-locked state when the USB port is connected to a computer, where the secure screen-locked state is preset in an operating system of the terminal device, and the screen that is locked can be successfully unlocked only after a user inputs correct unlocking information on the screen, and a control unit, connected to the detection unit and configured to control a debug port of the terminal device when the screen is in the secure screen-locked state.

With reference to the second aspect, in a first possible implementation manner, when the screen is in the secure screen-locked state, the control unit is further configured to disable the debug port.

With reference to the first possible implementation manner of the first aspect, in a second possible implementation manner, the detection unit is further configured to detect whether the screen is successfully unlocked, and when the screen is successfully unlocked, the control unit is further configured to enable the modulation port, or when the screen is unsuccessfully unlocked, the control unit is further configured to disable the debug port.

With reference to the second possible implementation manner of the first aspect, in a third possible implementation manner, the control unit is further configured to generate a historical record of the debug port according to an enabled state or a disabled state of the debug port.

With reference to the third possible implementation manner of the first aspect, in a fourth possible implementation manner, the detection unit is further configured to detect whether the USB port is disconnected from the computer, and when the USB port is disconnected from the computer, the control unit is further configured to clear the historical record of the debug port, or when the USB port remains connected to the computer, the control unit is further configured to detect whether the screen is in a screen-locked state, and when the screen is in the screen-locked state, the control unit is further configured to control the debug port according to the historical record of the debug port.

A status of a USB port of a terminal device and a status of a screen of the terminal device are detected, and a debug port of the terminal device is controlled according to a detection result. According to the method and apparatus for controlling a debug port in the present disclosure, security policy completeness of a terminal device can be improved, and security of user information on the terminal device is effectively ensured.

According to detailed descriptions of exemplary embodiments in the following accompanying drawings, other features and aspects of the present disclosure become clearer.

### BRIEF DESCRIPTION OF DRAWINGS

Accompanying drawings that are included in the specification and that constitute a part of the specification together with the specification illustrate exemplary embodiments, features, and aspects of the present disclosure, and are used to explain a principle of the present disclosure.

FIG. 1 shows a flowchart of a method for controlling a debug port according to an embodiment of the present disclosure;

FIG. 2 shows a flowchart of a method for controlling a debug port according to another embodiment of the present disclosure;

FIG. 3 shows a block diagram of an apparatus for controlling a debug port according to an embodiment of the present disclosure; and

FIG. 4 shows a block diagram of an apparatus for controlling a debug port according to another embodiment of the present disclosure.

### DESCRIPTION OF EMBODIMENTS

The following describes various exemplary embodiments, features, and aspects of the present disclosure in detail with reference to the accompanying drawings. Same reference signs in the accompanying drawings indicate components that have same or similar functions. Although various aspects of the embodiments are shown in the accompanying drawings, unless otherwise specified, the accompanying drawings do not need to be drawn to scale.

The word “exemplary” for exclusive use herein means “used as an example or embodiment or for a descriptive purpose”. Any embodiment described herein for an “exemplary” purpose does not need to be explained as being superior to or better than other embodiments.

In addition, to better describe the present disclosure, many specific details are provided in the following specific implementation manners. A person skilled in the art should understand that the present disclosure can still be implemented without these specific details. In some other instances, well-known methods, means, components, and circuits are not described in detail such that a main purpose of the present disclosure is highlighted.

### Embodiment 1

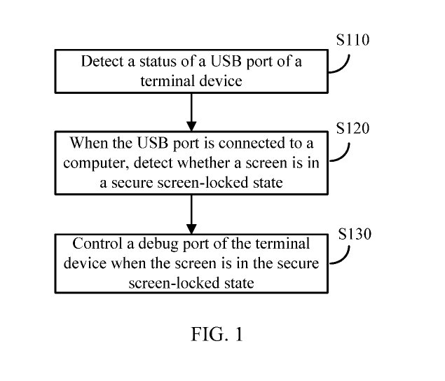

FIG. 1 shows a flowchart of a method for controlling a debug port of a terminal device according to an embodiment of the present disclosure. As shown in FIG. 1, the method for controlling a debug port mainly includes the following steps.

Step S110: Detect a status of a USB port of a terminal device.

Step S120: When the USB port is connected to a computer, detect whether a screen of the terminal device is in a secure screen-locked state.

Step S130: Control a debug port of the terminal device when the screen is in the secure screen-locked state.

On the device such as a smartphone or a tablet computer in which an operating system such as an ANDROID system is installed, a set of security policies may be added before the debug port such as an ADB port of the terminal device. The system may determine, by listening to a USB message of the terminal device, for example, a message indicating whether a USB port of the terminal device is connected to the computer by means of USB cable insertion, whether a USB event happens. If it is detected that the USB port is connected to the computer, it is determined that the USB event happens. In addition, it is further detected whether the screen of the terminal device is in the secure screen-locked state, and enabling or disabling of the debug port is controlled according to a detection result. The secure screen-locked state is preset in the operating system of the terminal device, and the screen that is locked can be successfully unlocked only after a user inputs correct unlocking information on the screen. The debug port can be enabled only in a case in which the screen is successfully unlocked, and the user is prompted to confirm whether to authorize debugging and whether to allow debugging. The ADB port is a debug port of the ANDROID system, and in a case in which the USB port is connected to the computer, the user manages the terminal device using the port and accesses user data stored on the terminal device, such as contacts or confidential files.

If the terminal device is lost, even though a third party cracks the terminal device using third-party tool software, the third party still cannot steal the user data using the debug port because after the USB port of the terminal device is connected to the computer, if security policy verification fails, the debug port is disabled using the method for controlling a debug port.

A status of a USB port of a terminal device and a status of a screen of the terminal device are detected, and a debug port of the terminal device is controlled according to a detection result. According to the method for controlling a debug port in the foregoing embodiment of the present disclosure, security policy completeness of a terminal device can be improved, and security of user information on the terminal device is effectively ensured.

It should be noted that although the ANDROID system is used as an example for describing the foregoing method for controlling a debug port, a person skilled in the art can understand that the present disclosure shall not be limited thereto. Actually, the foregoing method for controlling a debug port is also applicable to another operating system having a debug port, such as a WINPHONE system.

### Embodiment 2

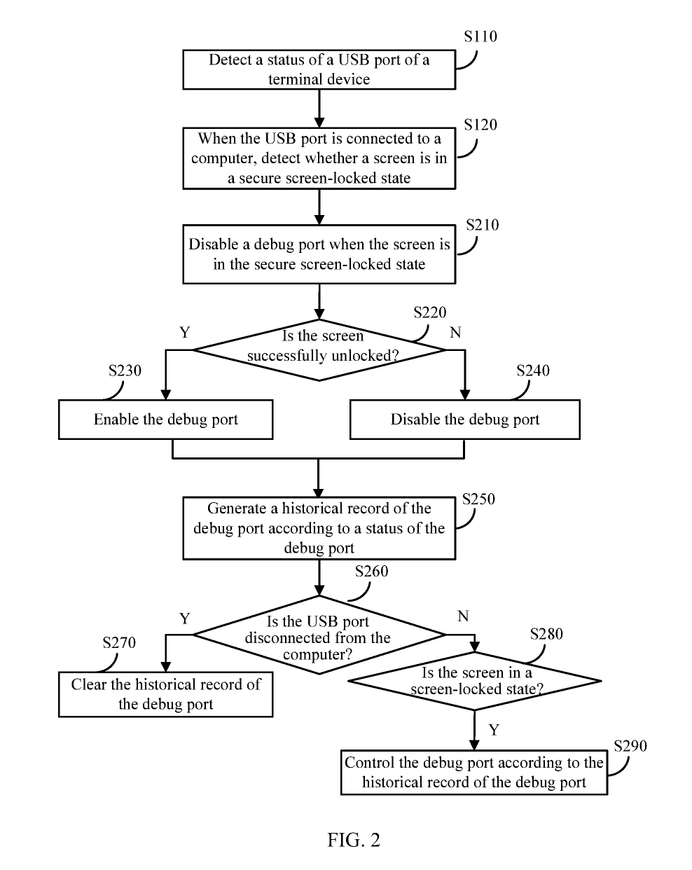

FIG. 2 shows a flowchart of a method for controlling a debug port of a terminal device according to another embodiment of the present disclosure. In FIG. 2, a component of which a mark is the same as that of a component in FIG. 1 has a same function. For brevity, detailed descriptions of these components are omitted.

As shown in FIG. 2, a primary difference between the method shown in FIG. 2 and the method shown in FIG. 1 lies in that, when a screen is in a secure screen-locked state, a debug port is first disabled, and the debug port can be enabled only after the screen is successfully unlocked.

Step S130 may further include the following steps.

Step S210: Disable the debug port when the screen is in the secure screen-locked state.

A screen-locked state refers to a state in which a screen of a terminal device is locked. The screen-locked state may include a secure screen-locked state and an insecure screen-locked state. For example, in the version of ANDROID J, a secure screen-locked state may include but is not limited to any one or more of a pattern screen lock, a personal identification number (PIN) screen lock, a password screen lock, and a face lock, and an insecure screen-locked state may include a two dimensional (2D) screen lock (for example, a slide screen lock), no screen lock, and the like. Compared with the insecure screen-locked state, for the secure screen-locked state, an unlocking manner is more complex. A user needs to input unlocking information on a locked screen, and the screen can be successfully unlocked only after the unlocking information is verified to be correct. Therefore, compared with the insecure screen-locked state, the secure screen-locked state has a higher security level. If the user sets a screen-locked state of the terminal device to be in the secure screen-locked state, it indicates that the user expects to protect security of user information stored on the terminal device and needs to prevent a third party from stealing the information.

If the terminal device is lost, a third party cannot access user data using the debug port because when the third party connects the USB port of the terminal device to a computer, if it is detected that the screen of the terminal device is in the secure screen-locked state, the debug port can be automatically disabled.

For the foregoing method for controlling a debug port, in a possible implementation manner, after step S210, the method may include the following steps.

Step S220: Detect whether the screen is successfully unlocked.

Step S230: Enable the debug port if the screen is successfully unlocked.

Step S240: Disable the debug port if the screen is unsuccessfully unlocked.

Furthermore, after it is detected that the screen is in the secure screen-locked state and the debug port is disabled, whether a user inputs unlocking information on the screen can be detected, that is, it is determined that the user has performed an unlock operation and has verified whether the unlocking information is correct. If the unlocking information is verified to be correct, the screen is to be successfully unlocked. For different secure screen-locked states, different manners need to be used for unlocking. For example, if the secure screen-locked state is a pattern screen-locked state, unlocking can succeed only after a user draws a correct pattern on the screen. If the secure screen-locked state is a PIN, unlocking can succeed only after a user inputs a correct PIN code on the screen. If the secure screen-locked state is a password screen-locked state, unlocking can succeed only after a user inputs a correct password on the screen. If the secure screen-locked state is a face screen-locked state, unlocking can succeed only after a terminal device identifies a correct face feature of a user. The debug port can be enabled only after the screen is successfully unlocked, or if the screen is unsuccessfully unlocked, the debug port continues to remain in a disabled state.

If the terminal device is lost, the debug port continues to remain in a disabled state because a third party cannot input correct unlocking information generally, that is, unlocking information is verified to be incorrect. Therefore, the third party cannot access, using the debug port, user data stored on the terminal device.

For the foregoing method for controlling a debug port, in a possible implementation manner, after step S230 or step S240, the method may include the following steps.

Step S250: Generate a historical record of the debug port according to an enabled state or a disabled state of the debug port.

Furthermore, if the screen is successfully unlocked and the debug port is enabled, the debug port is set to be in an enabled state in the historical record of the debug port. If the screen is unsuccessfully unlocked and the debug port is disabled, the debug port is set to be in a disabled state in the historical record of the debug port. Whether the screen is successfully unlocked can be learned according to the historical record of the debug port, and further whether the terminal device may be cracked by a third party is learned.

For the foregoing method for controlling a debug port, in a possible implementation manner, after step S250, the method may include the following steps.

Step S260: Detect whether the USB port is disconnected from the computer.

Step S270: Clear the historical record of the debug port when the USB port is disconnected from the computer.

Step S280: When the USB port remains connected to the computer, detect whether the screen is in a screen-locked state.

Step S290: When the screen is in the screen-locked state, control the debug port according to the historical record of the debug port.

Furthermore, a system may determine, by listening to a USB message of the terminal device, for example, a message indicating whether a USB port of the terminal device is disconnected from the computer by pulling out a USB cable, whether the USB event ends. If the USB port is disconnected from the computer, it is determined that a current USB event ends, and the historical record of the debug port is cleared. If the USB port remains connected to the computer, it is determined that a current USB event does not end, and the debug port may be enabled or disabled according to the historical record of the debug port, which includes the following cases.

Case 1: If a developer connects the terminal device to a computer using the debug port, the developer may perform development and debugging on the terminal device after successfully unlocking the screen and enabling the debug port. Afterwards, if the screen is in the screen-locked state again, for example, the terminal device enters a standby state and a screen-locked state because the developer does not operate the terminal device for a long time, and the USB port remains connected to the computer at this time, the debug port can continue to remain in an enabled state. In this way, the developer can continue to use the debug port, thereby avoiding that the developer needs to frequently unlock a screen in a development and debugging process, and improving experience of the developer.

Case 2: If the terminal device is lost, and a third party connects the terminal device to a computer using the debug port, the third party cannot read, using the debug port, user data stored on the terminal device because the third party unlocks the screen unsuccessfully and the debug port is disabled. Afterwards, if the screen is in the screen-locked state again and the USB port remains connected to the computer at this time, the debug port can continue to remain in a disabled state such that the third party still cannot access the user data using the debug port.

### Embodiment 3

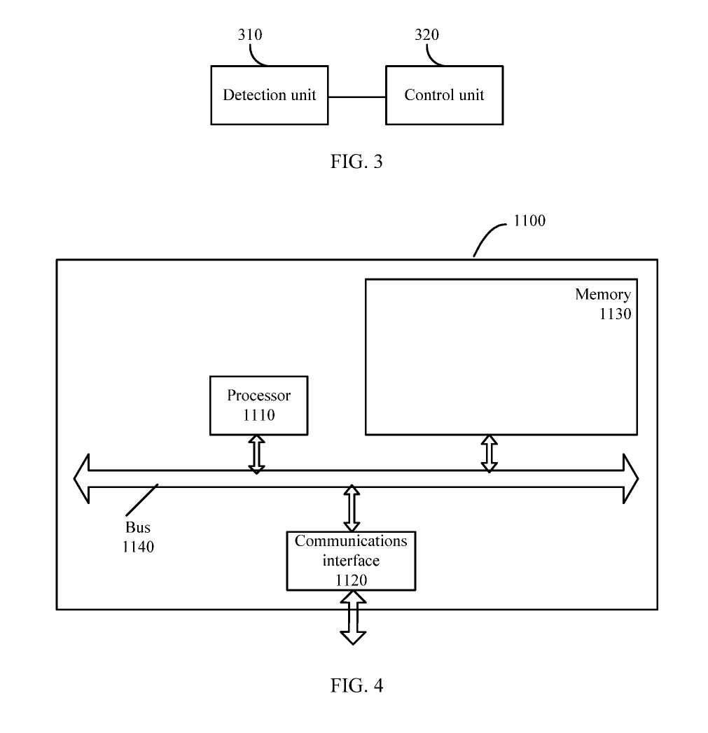

FIG. 3 shows a block diagram of an apparatus for controlling a debug port of a terminal device according to an embodiment of the present disclosure. As shown in FIG. 3, the apparatus for controlling a debug port mainly includes a detection unit 310 and a control unit 320. The detection unit 310 is mainly configured to detect a status of a USB port of a terminal device, and when the USB port is connected to a computer, detect whether a screen of the terminal device is in a secure screen-locked state, where the secure screen-locked state is preset in an operating system of the terminal device, and the screen that is locked can be successfully unlocked only after a user inputs correct unlocking information on the screen. The control unit 320 is connected to the detection unit 310 and mainly configured to control a debug port of the terminal device when the screen is in the secure screen-locked state.

For the foregoing apparatus for controlling a debug port, in a possible implementation manner, when the screen is in the secure screen-locked state, the control unit 320 is further configured to disable the debug port.

For the foregoing apparatus for controlling a debug port, in a possible implementation manner, the detection unit 310 is further configured to detect whether the screen is successfully unlocked, and when the screen is successfully unlocked, the control unit 320 is further configured to enable the modulation port, or when the screen is unsuccessfully unlocked, the control unit 320 is further configured to disable the debug port.

For the foregoing apparatus for controlling a debug port, in a possible implementation manner, the control unit 320 is further configured to generate a historical record of the debug port according to an enabled state or a disabled state of the debug port.

For the foregoing apparatus for controlling a debug port, in a possible implementation manner, the detection unit 310 is further configured to detect whether the USB port is disconnected from the computer, and when the USB port is disconnected from the computer, the control unit 320 is further configured to clear the historical record of the debug port, or when the USB port remains connected to the computer, the control unit 320 is further configured to detect whether the screen is in a screen-locked state, and when the screen is in the screen-locked state, the control unit 320 is further configured to control the debug port according to the historical record of the debug port.

For a specific mechanism for the foregoing apparatus for controlling a debug port to be configured to detect a status of a USB port of a terminal device and a status of a screen of the terminal device and control a debug port of the terminal device according to a detection result, reference may be made to FIG. 1, FIG. 2, and related descriptions of FIG. 1 and FIG. 2. According to the apparatus for controlling a debug port in the foregoing embodiment of the present disclosure, security policy completeness of a terminal device can be improved, and security of user information on the terminal device is effectively ensured.

It should be noted that although an ANDROID system is used as an example for describing the foregoing apparatus for controlling a debug port, a person skilled in the art can understand that the present disclosure shall not be limited thereto. Actually, the foregoing apparatus for controlling a debug port is also applicable to another operating system having a debug port, such as a WINPHONE system.

### Embodiment 4

FIG. 4 shows a block diagram of an apparatus for controlling a debug port according to still another embodiment of the present disclosure. The apparatus 1100 for controlling a debug port may be a host server with a computing capability, a personal computer (PC), or a portable computer or terminal that can be carried, or the like. Specific implementation of a computing node is not limited in a specific embodiment of the present disclosure.

The apparatus 1100 for controlling a debug port includes a processor 1110, a communications interface 1120, a memory 1130, and a bus 1140, where the processor 1110, the communications interface 1120, and the memory 1130 communicate with each other using the bus 1140.

The communications interface 1120 is configured to communicate with a network device, where the network device includes, for example, a virtual machine management center and a shared memory.

The processor 1110 is configured to execute a program. The processor 1110 may be a central processing unit (CPU) or an application-specific integrated circuit (ASIC), or may be configured as one or more integrated circuits for implementing this embodiment of the present disclosure.

The memory 1130 is configured to store a file. The memory 1130 may include a high-speed random-access memory (RAM), and may also include a non-volatile memory, for example, at least one magnetic disk memory. The memory 1130 may also be a memory array. The memory 1130 may also be divided into blocks, and the blocks can be combined into a virtual volume according to a specific rule.

For the foregoing apparatus for controlling a debug port, in a possible implementation manner, the foregoing program may be program code including a computer operating instruction. The program may be used for detecting a status of a USB port of a terminal device. When the USB port is connected to a computer, detecting whether a screen of the terminal device is in a secure screen-locked state, where the secure screen-locked state is preset in an operating system of the terminal device, and the screen that is locked can be successfully unlocked only after a user inputs correct unlocking information on the screen, and controlling a debug port of the terminal device when the screen is in the secure screen-locked state.

For the foregoing apparatus for controlling a debug port, in a possible implementation manner, the program is further used for disabling the debug port when the screen is in the secure screen-locked state.

For the foregoing apparatus for controlling a debug port, in a possible implementation manner, the program is further used for detecting whether the screen is successfully unlocked, and enabling the modulation port when the screen is successfully unlocked, or disabling the debug port when the screen is unsuccessfully unlocked.

For the foregoing apparatus for controlling a debug port, in a possible implementation manner, the program is further used for generating a historical record of the debug port according to an enabled state or a disabled state of the debug port.

For the foregoing apparatus for controlling a debug port, in a possible implementation manner, the program is further used for detecting whether the USB port is disconnected from the computer after generating the historical record of the debug port, and clearing the historical record of the debug port when the USB port is disconnected from the computer, or detecting whether the screen is in a screen-locked state when the USB port remains connected to the computer, and controlling the debug port according to the historical record of the debug port when the screen is in the screen-locked state.

For a specific mechanism for the foregoing apparatus for controlling a debug port to be configured to detect a status of a USB port of a terminal device and a status of a screen of the terminal device and control a debug port of the terminal device according to a detection result, reference may be made to FIG. 1, FIG. 2, and related descriptions of FIG. 1 and FIG. 2. According to the apparatus for controlling a debug port in the foregoing embodiment of the present disclosure, security policy completeness of a terminal device can be improved, and security of user information on the terminal device is effectively ensured.

It should be noted that although an ANDROID system is used as an example for describing the foregoing apparatus for controlling a debug port, a person skilled in the art can understand that the present disclosure shall not be limited thereto. Actually, the foregoing apparatus for controlling a debug port is also applicable to another operating system having a debug port, such as a WINPHONE system.

A person of ordinary skill in the art may be aware that, exemplary units and algorithm steps in the embodiments described in this specification may be implemented by electronic hardware or a combination of computer software and electronic hardware. Whether the functions are implemented by hardware or software depends on particular applications and design constraint conditions of the technical solutions. A person skilled in the art may select different methods to implement the described functions for a particular application, but it should not be considered that the implementation goes beyond the scope of the present disclosure.

If the functions are implemented in a form of computer software and sold or used as an independent product, it can be deemed to some extent that all or some of the technical solutions of the present disclosure (for example, the part contributing to the prior art) are implemented in a form of a computer software product. The computer software product is generally stored in a computer readable storage medium and includes several instructions for instructing a computer device (which may be a personal computer, a server, a network device, or the like) to perform all or some of the steps of the methods described in the embodiments of the present disclosure. The foregoing storage medium includes any medium that can store program code, such as a USB flash drive, a removable hard disk, a read-only memory (ROM), a RAM, a magnetic disk, or an optical disc.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1-10. (canceled)

11. A method for controlling a debug port of a terminal device, comprising:
detecting a status of a universal serial bus port of the terminal device;
detecting whether the terminal device is in a secure screen-locked state when the universal serial bus port is connected to a computer, wherein the secure screen-locked state is preset in an operating system of the terminal device, and wherein a screen that is locked can be successfully unlocked only after a user inputs correct unlocking information on the screen; and
controlling a debug port of the terminal device when the terminal device is in the secure screen-locked state.

12. The method according to claim 11, wherein controlling the debug port of the terminal device when the terminal device is in the secure screen-locked state comprises disabling the debug port when the terminal device is in the secure screen-locked state.

13. The method according to claim 12, wherein after disabling the debug port when the terminal device is in the secure screen-locked state, the method further comprises:
detecting whether the screen is successfully unlocked;
enabling the debug port when the screen is successfully unlocked; and
disabling the debug port when the screen is unsuccessfully unlocked.

14. The method according to claim 13, wherein after enabling the debug port when the screen is successfully unlocked, and wherein after disabling the debug port when the screen is unsuccessfully unlocked, the method further comprises generating a historical record of the debug port according to an enabled state or a disabled state of the debug port.

15. The method according to claim 14, wherein after generating the historical record of the debug port, the method further comprises:
detecting whether the universal serial bus port is disconnected from the computer;
clearing the historical record of the debug port when the universal serial bus port is disconnected from the computer;
detecting whether the terminal device is in a screen-locked state when the universal serial bus port remains connected to the computer; and
controlling the debug port according to the historical record of the debug port when the terminal device is in the screen-locked state.

16. An apparatus for controlling a debug port of a terminal device, comprising:
a memory; and
a processor coupled to the memory and configured to:
detect a status of a universal serial bus port of the terminal device;
detect whether the terminal device is in a secure screen-locked state when the universal serial bus port is connected to a computer, wherein the secure screen-locked state is preset in an operating system of the ter al device, and wherein a screen that is locked can be successfully unlocked only after a user inputs correct unlocking information on the screen; and
control a debug port of the terminal device when the terminal device is in the secure screen-locked state.

17. The apparatus according to claim 16, wherein when the terminal device is in the secure screen-locked state, the processor is further configured to disable the debug port.

18. The apparatus according to claim 17, wherein the processor is further configured to:
detect whether the screen is successfully unlocked;
enable the debug port when the screen is successfully unlocked; and
disable the debug port when the screen is unsuccessfully unlocked.

19. The apparatus according to claim 18, wherein the processor is further configured to generate a historical record of the debug port according to an enabled state or a disabled state of the debug port.

20. The apparatus according to claim 19, wherein the processor is further configured to:
detect whether the universal serial bus port is disconnected from the computer;
clear the historical record of the debug port when the universal serial bus port is disconnected from the computer;
detect whether the terminal device is in a screen-locked state when the universal serial bus port remains connected to the computer; and
control the debug port according to the historical record of the debug port when the terminal device is in the screen-locked state.
